(19) United States
(12) Patent Application Publication
(10) Pub. No.: US 2007/0200688 A1
(43) Pub. Date: Aug. 30, 2007

(54) Vehicle security system

(76) Inventors: Michael Tsz Ho Tang, Hong Kong (HK); Alex Key, Hong Kong (HK); Jonathan Lewis-Evans, Hong Kong (HK)

Correspondence Address: Edward G. Greive;Renner, Kenner, Greive, Bobak, Taylor & Weber, Fourth Floor, First National Tower, Akron, OH, 44308-1456, US

(21) Appl. No.: 11/363,354

(22) Filed: Feb. 27, 2006

(51) Int. Cl. B60R 25/10; H04K 3/00

(52) U.S. Cl. 340/426.18; 455/1

(57) ABSTRACT

A vehicle security system for use in a predefined area such as a car park includes an array of sensors (9) for receiving a vehicle alarm signal transmitted by radio frequency from a system-subscribing vehicle fitted with a transceiver (22) in the event of attempted vehicle tampering or removal. A control centre (12) receives alarm signals and communicates them to a user as an alarm message. Detection of radio frequency signal jamming or attempted jamming is achieved in one embodiment with noise detectors (39, 139) actively detecting jamming noise or alternatively an arrangement of transmitters and receivers using test transmissions therebetween, whereby transmission failure indicates jamming.

### BACKGROUND OF THE INVENTION

The present invention relates to a security system for vehicles which are parked in a predefined area, such as a car park.

A variety of vehicle security devices exist. Most new vehicles include anti-theft devices such as built-in alarms to indicate an unauthorized event such as a door, window or hood being forced open or tampered with. These alarms typically use an audible signal and flashing lights to alert others of the unauthorized entry. More complicated systems employ immobilisers which seek to prevent the vehicle from being operated without the appropriate key, and use a fuel or other type of cut-out to physically immobilise the vehicle.

With constant exposure to car alarms the public take little, if any, notice of such alarms these days. Many of these simple systems are therefore, regrettably, of limited deterrence to vehicle theft or tampering.

More sophisticated systems employ a vehicle tracking functionality generally requiring the vehicle to be fitted with a transceiver which transmits a signal to a tracking receiver allowing the vehicle location to be identified. Such signals are generally via a radio frequency communication, and may also interact with in-vehicle devices such as immobilisers to allow remote vehicle control.

One area where there are particular difficulties in providing security for vehicles, and yet where it should be feasible to do so, is where vehicles are parked in car parks. Car parks, especially multi-storey car parks, commonly have areas where people can tamper with vehicles relatively unnoticed. On the other hand, by their very nature, car parks are defined areas typically with a single or very small number of vehicle exit points.

It has previously been proposed to use a radio-frequency based monitoring system adapted for specific use within a car park environment. An example of such a system is discussed in U.S. Pat. No. 4,990,890.

Such radio-frequency based systems are however nonetheless susceptible to malicious attack, in that it is relatively easy to obtain devices which can locally interrupt radio frequency communication by emitting a jamming signal, such as high amplitude white noise.

The present invention seeks to provide a vehicle security system for providing effective security and enhanced functionality over existing systems.

### SUMMARY OF THE INVENTION

According to the present invention there is provided a vehicle security system for use in a predefined area comprising radio frequency receiving means for receiving a vehicle alarm signal from a subscribing vehicle in the event of attempted vehicle tampering or removal; control means for receiving said signal and communicating to a user as an alarm message; and means for detection of radio frequency signal jamming or attempted jamming, and for providing a jamming alarm signal for communication to a user.

The means for detection of radio frequency signal jamming may comprise one or more noise detectors adapted to detect radio frequency noise at a specified frequency or frequency range and to output a jamming alarm if said detected noise exceeds a predetermined threshold.

The radio frequency receiving means will typically comprise an array of sensors each comprising transceivers, the sensor array being distributed over the predefined area, such as a car park. The sensors may be connected to a control centre which receives the vehicle alarm signals and jamming alarm indications and communicates them to a user and/or to a further remote control centre.

In a preferred embodiment the noise detectors are incorporated into the sensors. Alternatively, the noise detectors may be incorporated into subscribing vehicles, as part of the vehicle transceiver units. In a further alternative arrangement the noise detectors may be dedicated noise detection units separate from said sensors or vehicles, in radio frequency communication with said sensors. With the latter two arrangements the noise detectors may be adapted to detect an increasing noise signal, and to output a jamming indication as a radio frequency signal at a higher amplitude than said detected noise.

The noise detectors may be arranged to output a jamming alarm signal on detection of an excessive noise condition only after a predetermined time, in order to avoid false jamming alarms possibly caused by transmitory radio frequency noise from stray devices or machinery, such as generators or the like.

In an alternative passive noise detection technique the means for detecting of radio frequency jamming comprise at least one radio frequency transmitter adapted to send test messages to a radio frequency receiver, a jamming indication signal being generated in the absence of receipt of said test message. The system preferably requires an array of sensors provided distributed over said predefined area, said sensors comprising transceivers which constitute each of said vehicle alarm receiving means and said radio frequency receivers of said jamming detection means, and said radio frequency transmitters, said sensors being adapted to periodically send test messages to other sensors, the system generating a jamming indication in the event of the absence of receipt of said test messages.

Alternatively, an array of monitoring devices including further transceivers are provided, wherein the sensors are adapted to send test signals to said monitoring devices which on receipt in turn send acknowledge signals back to the transceivers of said sensors, the system generating a jamming indication in the event of the absence of an acknowledge signal.

In a further alternative, the sensor array has transceivers which constitute said vehicle alarm receiving means and said radio frequency transmitters, wherein the sensors are adapted to send test messages to in-vehicle transceivers which in response to such test messages return acknowledge signals to the sensors, the system generating a jamming indication in the event of the absence of an acknowledge signal.

In a still further alternative the sensor array comprises transceivers which constitute said vehicle alarm receiving means and said radio frequency transmitters, wherein the sensors are further adapted to receive test signals sent from in-vehicle transceivers, and in response to generate and transmit acknowledge signals to in-vehicle transceivers, the absence of an acknowledge signal to said in-vehicle transceiver generating a jamming indication signal.

The latter two alternatives require that the sensors are further adapted to receive signals from vehicles which are leaving the predefined area, the system preventing the absence of acknowledge signals from such vehicles from triggering jamming indications.

The sensors are preferably connected to a local control centre which includes a database of data relating to subscribing vehicles and their owners, which may in turn be further connected to a remote centre possibly linked to several predefined areas such as car parks or the like.

The system may further comprise exit restraint means for securing on request said area exit points against vehicle exit, and processing means for processing vehicle alarm signals from a subscribing vehicle within said area and outputting command signals to said exit restraints. These may be in the form of movable barriers, grilles or wheel traps.

In-vehicle sensing means may be provided to sense tampering with the vehicle or unauthorized operation, and outputting the alarm signal, such as a door sensor, hood sensor, ignition sensor, and vehicle interior movement sensor. Vehicle immobilising means may comprise one or more of a starter motor cut-out, fuel pump cut-out, fuel line cut-out and electrical fuse burn.

### BRIEF DESCRIPTION OF THE DRAWINGS

An embodiment of the present invention is now described, by way of example only, with reference to the following drawings in which:

FIG. 1 is a schematic overview of a vehicle security system;

FIG. 2 is a schematic representation of an in-vehicle security system;

FIG. 3 illustrates the main communication sequence between system components;

FIG. 4 is a schematic representation of a system configured for jamming detection, in accordance with a first embodiment of the invention;

FIG. 5 is a schematic representation of a system configured for jamming detection in accordance with a second embodiment of the invention;

FIG. 6 is a schematic representation of a system configured for jamming detection in accordance with a third embodiment of the invention;

FIG. 7 is a schematic representation of a system configured for jamming detection in accordance with a fourth embodiment of the invention;

FIG. 8 is a schematic representation of a system sensor;

FIG. 9 illustrates further the communication sequence of the system of FIG. 7, in a normal condition; and

FIG. 10 illustrates the communication sequence of the system of FIG. 7 in a jamming detection condition.

### DETAILED DESCRIPTION OF THE PREFERRED EMBODIMENTS

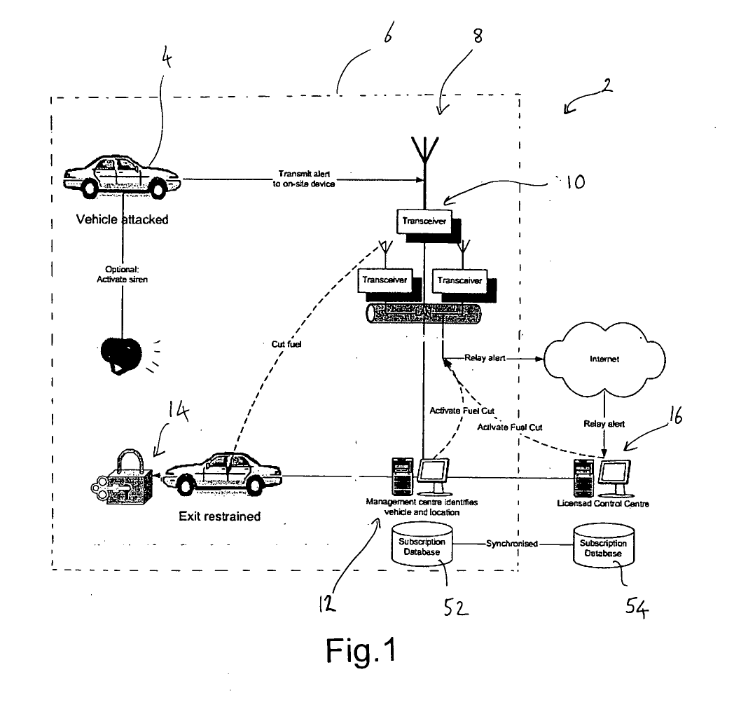

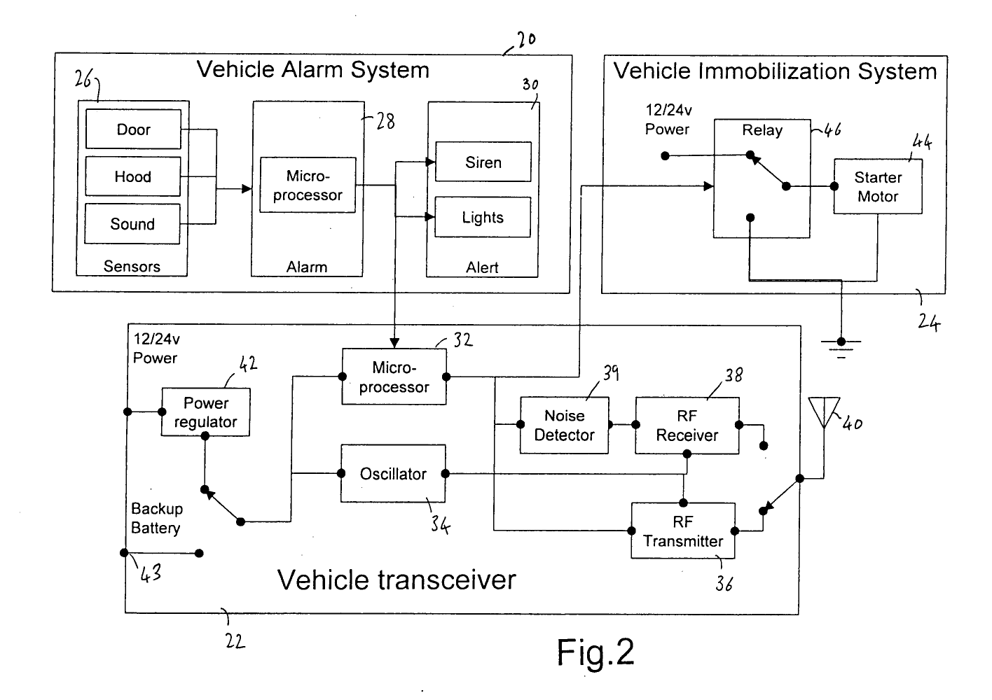

Turning to the drawings, FIGS. 1 and 2 illustrate schematic overviews of the vehicle security system according to a preferred embodiment of the invention. The security system, generally indicated 2, provides security for vehicles within a predefined preferably securable area, indicated 6.

Although the system finds particular applicability for the security of land vehicles such as cars, trucks etc, as indicated 4 in FIG. 1, the system could equally be applied in the marine environment to boats, particularly where these are moored within a marina, which typically would also have a limited number of exit points. In the land application the securable area 6 is a car park, which may be a simple open air parking lot, or equally a multi-storey high rise and/or underground car park.

In outline, the vehicle 4 includes one or more in-vehicle security devices, as discussed further below. The in-vehicle security devices communicate with an on-site security control system 8, preferably through a radio frequency link. This on-site system 8 includes communications hardware such as an array of suitably positioned monitoring sensors 9 each including a transceiver 10 connected to a control system including a local management centre 12. The management centre 12 can provide or control a variety of alerts and/or disabling actions, such as alerting security personnel and/or the vehicle owner or user of the attack on the vehicle, activating in-vehicle immobilizing devices, activating exit restraints 14 at the exit for the car park such as closable gates, barriers or extendable wheel traps. The management centre 12 may also communicate with one or more remote centres 16, which may be control centres of the same or a related commercial undertaking or other types of entities such as the police or other emergency services.

The in-vehicle system is described in more detail with reference to FIG. 2. The system comprises three main sub-systems, including alarm sub-system 20, vehicle transceiver sub-system 22 and immobilization sub-system 24. The alarm sub-system 20 includes one or more vehicle sensors 26 which detect for example the forcing of a door, hood or window, or detect internal sound or movement. These are operatively connected to a control microprocessor 28. On receipt of a signal from any of the vehicle sensors 26 the microprocessor 28 adopts an “alarm” condition, activating in-vehicle alerts 30, which may include audible sirens, and flashing lights.

In an “alarm” condition the alarm sub-system 20 activates the transceiver sub-system 22. This comprises a control microprocessor 32, oscillator 34 providing clocking control, a radio frequency transmitter 36, and radio frequency receiver 38. A noise detector 39 is provided for detection of excessive noise, such as might be associated with an attempt to jam the system, as will be discussed further below. A single antenna 40 is illustrated with a switch allowing controlled selection, depending on a transmission or reception status, but equally individual antennae could be provided for each. A power supply/regulation circuit 42 provides system power from the main vehicle battery, at typically 12V or 24V, with a back-up (and generally concealed) battery 43 also provided, as is conventional for vehicle security systems to prevent system failure in the event of tampering or disconnection of the main battery.

The alarm sub-system 20 and transceiver sub-system 22 may also be connected to a vehicle immobilization sub-system 24. A variety of vehicle immobilization techniques may be utilized, including but not limited to:
a) Starter motor cut-out. As illustrated in FIG. 2, the microprocessor 32 controls a relay 46 which disconnects the starter motor 44 from the power supply.
b) Fuel pump cut-out. The microprocessor 32 controls interruption of the electrical supply to the vehicle fuel pump, causing fuel to stop flowing through the fuel system.
c) Fuel line cut-out. A mechanical flow valve within the fuel line or carburetor or other component is controlled to interrupt fuel supply.
d) Fuse burn. One or more essential electrical systems within the vehicle are disabled by the deliberate oversupply of current to an electrical fuse within one of these electrical systems.

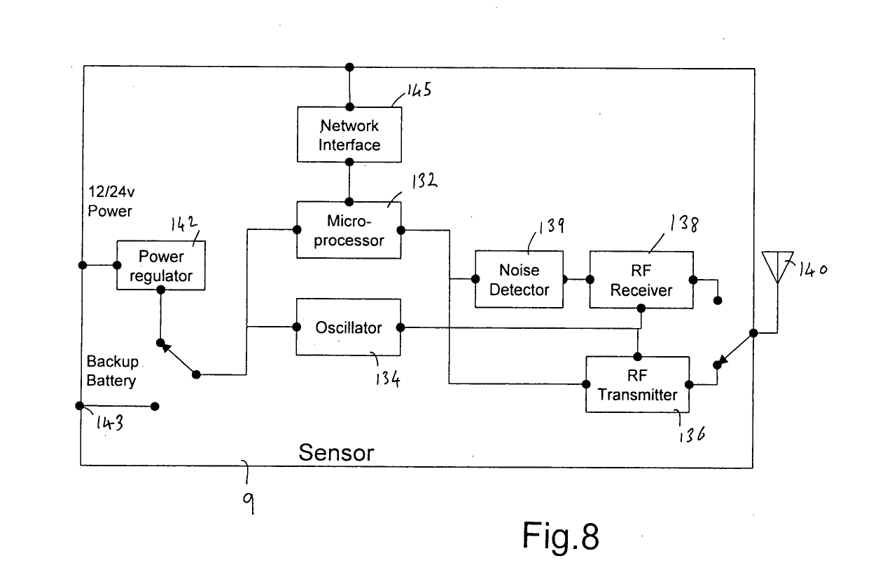

As discussed above the car park or other securable area generally indicated 6 in FIG. 1 is equipped with means allowing two-way communication with vehicles 4 parked at any location therein. In the case of a ground level open air car park at its simplest this might comprise a single on-site transceiver. More typically, in the case of a multi-storey car park this would comprise an array of monitoring sensors 9 each including a transceiver 10 distributed throughout the car park so that at no location therein is there any communication blind spot. More particularly, as shown in FIG. 8, the sensors include a similar structure to the in-vehicle transceivers 22, including a radio frequency transmitter 136 with associated antenna 140 and radio frequency receiver 138. Oscillator 134 provides timing control. A microprocessor 132 provides internal control, in a manner as discussed further below. The system sensors 9 may be permanently connected to a power supply, most conveniently the mains power supply for the car park itself, via a power regulator 142. An internal back-up battery 147 may also be provided. Typically, the sensors 9 would not need to transmit at more than about 2 watts. The antenna may be a variety of different types depending on the car park topology; for example a dipole type is suitable for mounting in more open areas where space is available and coverage is generally line of sight from the antenna location (eg from poles, nearby rooftops, side walls etc). Where space is not an issue, a quarter wave length type antenna with grounding plane might be utilized, for example on rooftops. Where security of the sensor system is particularly important, printed circuit board-type antennas might be utilized. These have more limited coverage but are easy to conceal. In enclosed areas where standard dipole or quarter wavelength radiators results in coverage blind spots radiating co-axial cables might be utilized. The sensors 9 may also incorporate a noise detector 139 for use in detection of signal jamming, as discussed further below.

Ideally, the frequency of communication is one which is reserved for the operator of the service as this affords increased security. Typically, the frequency is in the VHF (very high frequency) or UHF bands (ultra high frequency). VHF is ideal for short distance communication, being relatively free of inference from electrical equipment. Typically, operation in the range 30 MHz to 300 MHz (wavelength 10 m to 1 m) is employed. UHF frequencies generally similar to those used in mobile communications in GSM, CDMA and 802.11 implementations can also be used, with the advantage that there are many proprietary antenna designs particularly appropriate for deployment in confined areas.

The array of sensors 9 is connected to an on-site control centre 12 which includes a computer 50 or other processing means, interconnected through a network interface 145, within each sensor and through a local area network (LAN), of wired or wireless type. The control centre 12 may be dedicated to the security system 2 or may be integrated with a control or management system of the car park operator or building management. Typically, the control centre 12 is staffed by personnel who, when an alert is received, may investigate the attack or take other action as appropriate. The computer 50 may store details of subscribing vehicles 4, such as vehicle type, registration number, owner details and contact details, and in the case of car parks where particular vehicles have allocated parking spaces, the location of the parking space all in a local database, indicated 52.

As an alternative or in addition to the local management centre 12, a remote control centre 16 may be in communication with the LAN either by dedicated line or via the Internet or other suitable connection. For example, a wireless communication might be used where the transceivers 10 include an antenna typically of higher power than those for the on-site communication. The remote control centre 16 might usefully provide control of a number of on-site control centres, including a database 54 of subscriber details which is regularly synchronized with individual on-site databases 52.

The local management centre 12 (or indeed remote management centre) may be connected to one or more security devices within the car park, such as exit restraints generally indicated 14 in the form of closable gates or barriers or grilles, or wheel traps. These may be operated automatically on an alert being received, or activated manually by security personnel at the management centre.

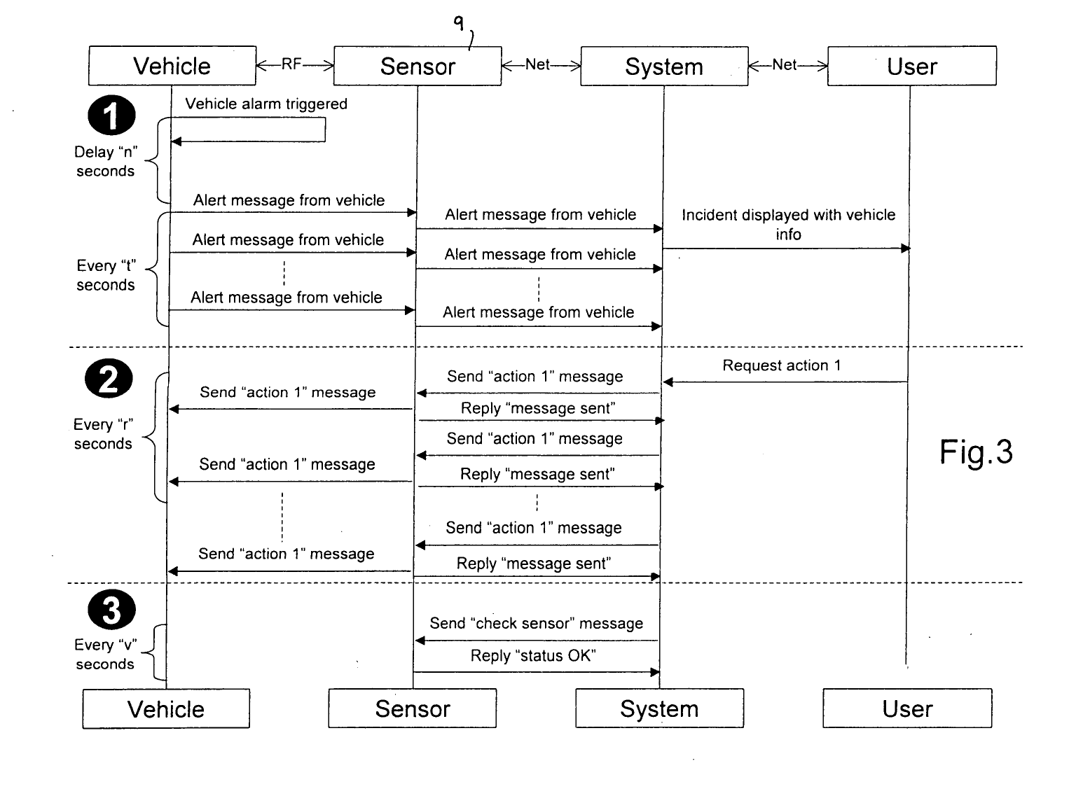

The operation of the system 2 in response to an attack on a vehicle is now described, predominantly with reference to FIG. 3. In the event of an attack on the vehicle, and sensing of the attack by one or more of the in-vehicle sensors 26, the internal vehicle alarm is triggered. A short predetermined delay is programmed into the microprocessor 28 and/or 32 before an alert message is transmitted from the vehicle transceiver 22 as a radio frequency signal. The delay allows for the cancellation of the alarm condition in the event of false triggering by the vehicle user or authorised personnel, for example when conducting testing or installation, or false activation by the vehicle user. The alert message contains proxy information that identifies the vehicle, and identifies various vehicle status criteria including one or more of door state, hood state, ignition state, main battery state, and a variety of other possible status information.

The alert message is received by one or more nearby system sensors 9 which relay it via the LAN to the control centre 12. The vehicle identity as identified by the alert message is matched with stored information about the vehicle and its owner, and an incident report generated containing information such as date and time of alert, vehicle make, model and colour, registration number, usual parking location, and the reporting transceiver location.

This incident report is displayed to the user, typically security personnel within the control centre 12, but may also be sent to the vehicle owner. The same alert message is repeatedly sent from the vehicle every “t” seconds, received by the sensor(s) 9, and forwarded via the LAN to the control centre 12, and if any change since the previous report then updating the incident report.

On receipt of the incident report, if appropriate the user is able to dispatch security personnel to investigate. The user is also able to initiate an action within the vehicle (indicated “action 1” in FIG. 3) such as the control centre 12 generates an “action 1 message” which is directed at least to the reporting system sensor, and transmitted to the vehicle 4. The actions include events such as immobilizing commands, or a request seeking a status report on the vehicle condition. The sensor(s) 9 generates a “message sent” reply following the transaction of each “action” message. The “action 1” message may be repeatedly sent every “r” seconds until acknowledged.

The system 2 is able to perform internal checks of sensors. To this end the control centre 12 generates every “v” seconds “check sensor” messages to the complete set of transceivers, which generate “status OK” replies in response. The absence of such a reply indicates to the user that a sensor is not functioning correctly and must be repaired or that jamming may be taking place as further described below.

A particularly important feature of the system is the provision of means to detect attempts to jam the system. It is relatively easy for those of malicious intent to obtain devices which prevent, within a localized area, the operation of radio frequency communications. Typically, such devices emit white noise at a particular or spread of frequencies, thereby drowning out communications at that frequency.

In an active jamming detection system, the sensor array 9 and/or the in-vehicle transceiver 22 can be adapted so that each sensor or transceiver incorporates a noise detection circuit, including an appropriate filter to remove irrelevant frequencies, and logic control whereby the detected noise level at a specified frequency or range of frequencies (being at or about the frequency of communication of the security system, ie the transceiver-sensor communication) is compared in a comparator to a specified noise value, and if exceeding that value, sending a signal to the control system indicative of a possible jam condition. FIG. 2 illustrates a noise detector 39 incorporated within the vehicle transceiver. FIG. 8 illustrates a noise detector 139 incorporated within a sensor. In such an arrangement the sensitivity of the noise detection circuit is important. Typically, one would pre-calibrate the noise detection circuit so as to ensure only noise significantly above a background ambient noise triggers the jam indication. Furthermore, it is desirable to exclude transmitory stray noise events, such as might be caused by the start-up of machinery such as generators, which exclusion might be achieved by triggering of the jam indication only after a predetermined period.

As an alternative, dedicated noise detectors separate from the sensor array 9 could be distributed throughout the securable area 6 and connected in a wired or wireless manner to the LAN.

As a further alternative, dedicated noise detectors separate from the sensor array 9 could be distributed throughout the securable area 6, and in radio frequency communication with the sensor array. In this case, since the communication is possibly interrupted by a jamming signal, the noise detector would include appropriate control or logic to monitor an increasing noise signal and to transmit a jamming detected signal prior to communication loss, preferably at a stronger signal strength for a short duration.

As an alternative to the use of an “active” jamming detection using noise detection, various passive jamming detection systems are possible, in which instead of actively triggering a jamming indication on noise detection, the breakdown of radio frequency communication of system components is used as an indication of a possible jamming event.

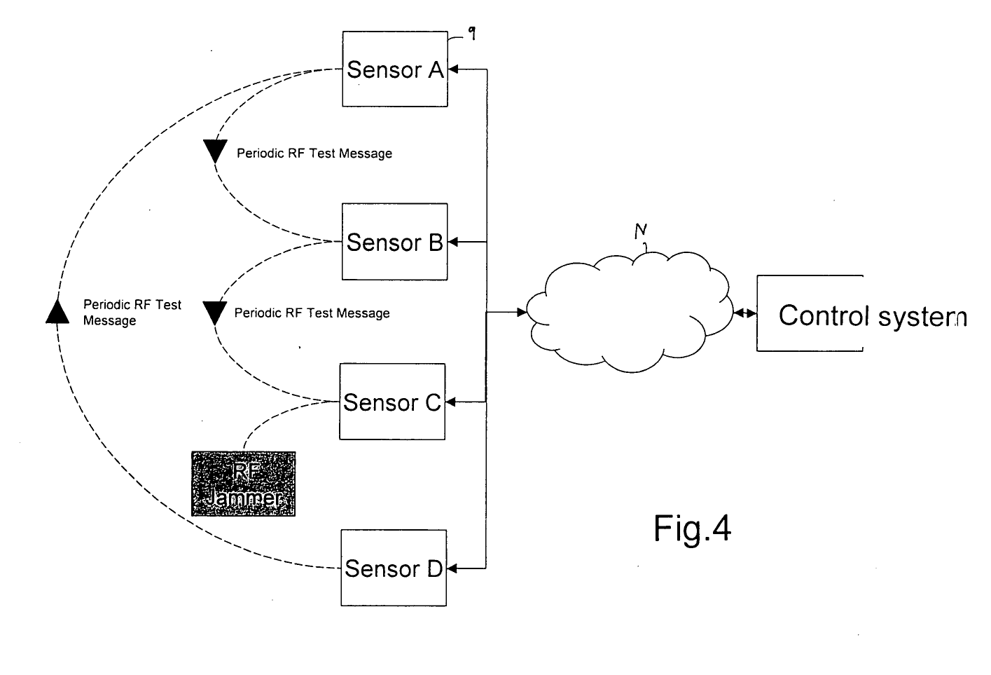

FIG. 4 illustrates a “self aware” sensor arrangement whereby the individual sensors 9 are controlled through their internal microprocessors 132 to periodically send a radio frequency test message to another sensor or sensors, with detection of the message receipt reported via the network indicated N (which may be a LAN or a variety of other network types) to the local control system as a “sensor OK” or “acknowledge receipt” status message. In the event of the use of a radio frequency jammer the communication between sensors in the vicinity of the jammer is interrupted. In FIG. 4 the jammer is shown located between sensors C and D, whereby the test message from sensor C to D is interrupted. The failure by sensor D to receive the test message is perceived by the control system as an indication of a possible jamming event in the vicinity of sensors C and D. In response, the system can indicate an alarm condition resulting in closing of exit restraints and/or investigation by security personnel at the management centre, and specifically in the locality of sensors C and D.

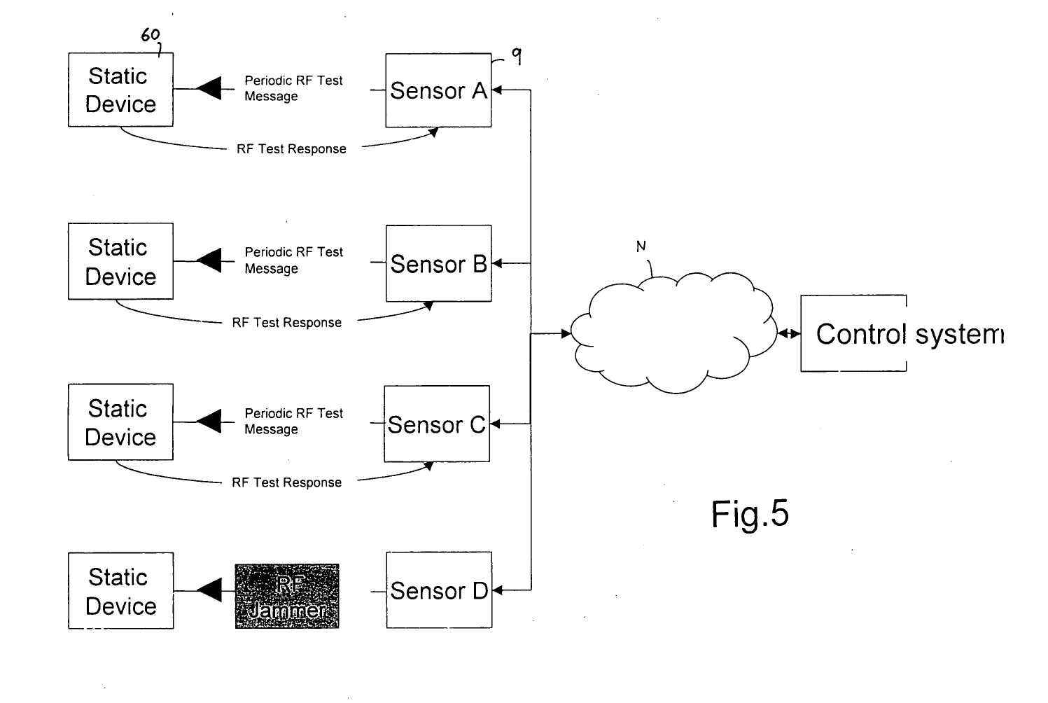

FIG. 5 illustrates an alternative passive system which includes one or more static radio frequency devices indicated 60 each including a radio frequency transceiver with appropriate internal microprocessor control. Preferably, a plurality of separate devices 60 are utilized, distributed over the securable area 6. The system is configured so that sensors of the sensor array 9 send periodic radio frequency test messages to the static devices 60, which in response send by radio frequency transmission response messages to be received by the sensor 9. Receipt of the response is indicative of a functioning sensor. It may be arranged that each sensor 9 has an associated static device 60, although many other arrangements may be utilized. In a jamming event sufficient to interrupt the communication of a sensor 9, indicated in FIG. 5 by the radio frequency jammer in the vicinity of sensor D, the test message from sensor D is interrupted, whereby no response is triggered. The failure to receive a response from sensor D is interpreted as indicative of signal jamming in the vicinity of sensor D, triggering an alarm and/or appropriate investigation.

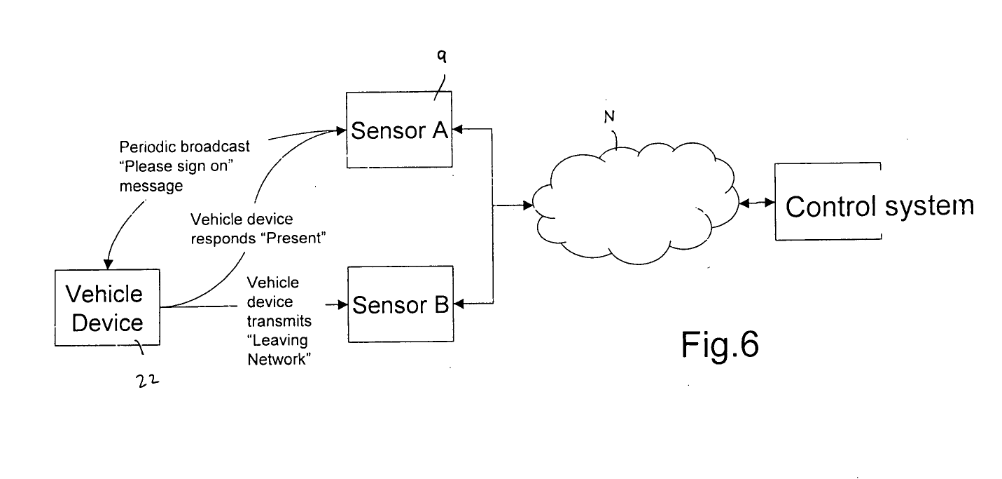

FIG. 6 illustrates an alternative embodiment utilizing a passive detection whereby radio communications with in-vehicle transceivers 22 are used as a basis for jamming detection. The system arranges that the nearest sensor, sensor A sends a periodic broadcast of a “please sign on” message to the in-vehicle transceiver 22, with the vehicle responding with a “present” message. Receipt of the “present” message at sensor A indicates normal function of sensor A. In the event of the failure by sensor A to receive a “present” message, a jamming event message is sent via the LAN to the control system. Because the vehicle may be removed from the securable area 6 by the vehicle owner, and thereby removed from the jamming detection system in which case the vehicle transceiver 22 would inevitably be unable to communicate with sensor A, the system must be able to differentiate between jamming and vehicle removal. This is effected by arranging the vehicle transceiver 22 to transmit a “leaving network” message on its removal. This signal is automatically sent by the vehicle transceiver 22 when the vehicle is moved.

Such signal may be triggered internally, for example by detection of start-up of the vehicle engine, or through detection of the vehicle passing an exit point in the securable area 6. Thus, depending on the precise details the “leaving network” signal may be detected by the sensor A, or at a different sensor, such as sensor B as indicated in FIG. 6. Once a “leaving network” message is received that vehicle device is thereby excluded from participating in the jamming detection system. Since the system cannot rely on the presence of any particular individual vehicle at any moment, the system will preferably communicate with numerous vehicles distributed over the securable area 6. Although the absence of a “present” signal from any one vehicle at any one sensor can be used to trigger a jamming event message, it may be arranged that the system requires the failure of N “present” messages where N is greater than one.

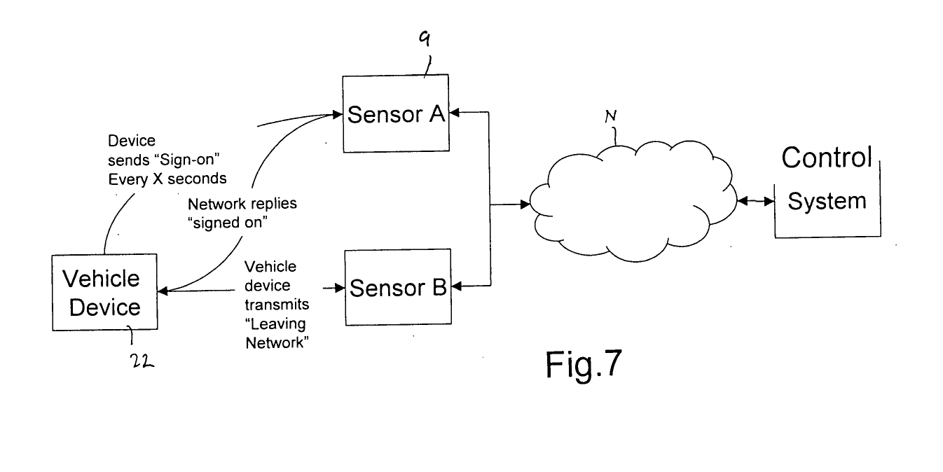

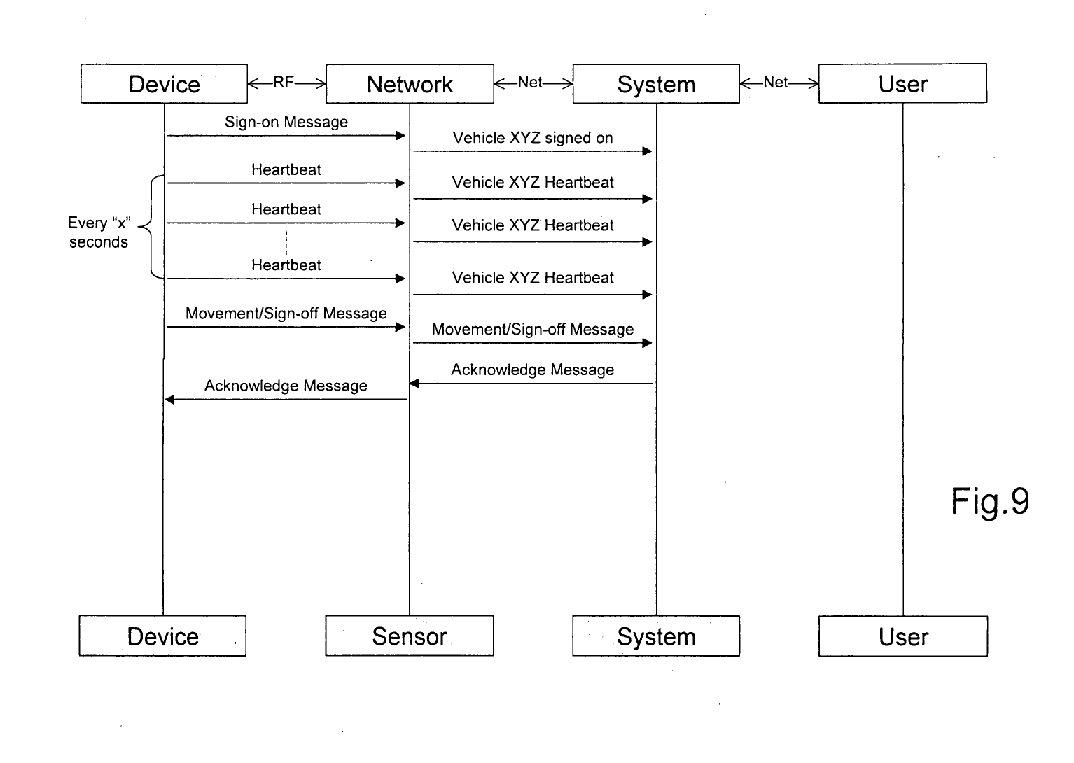

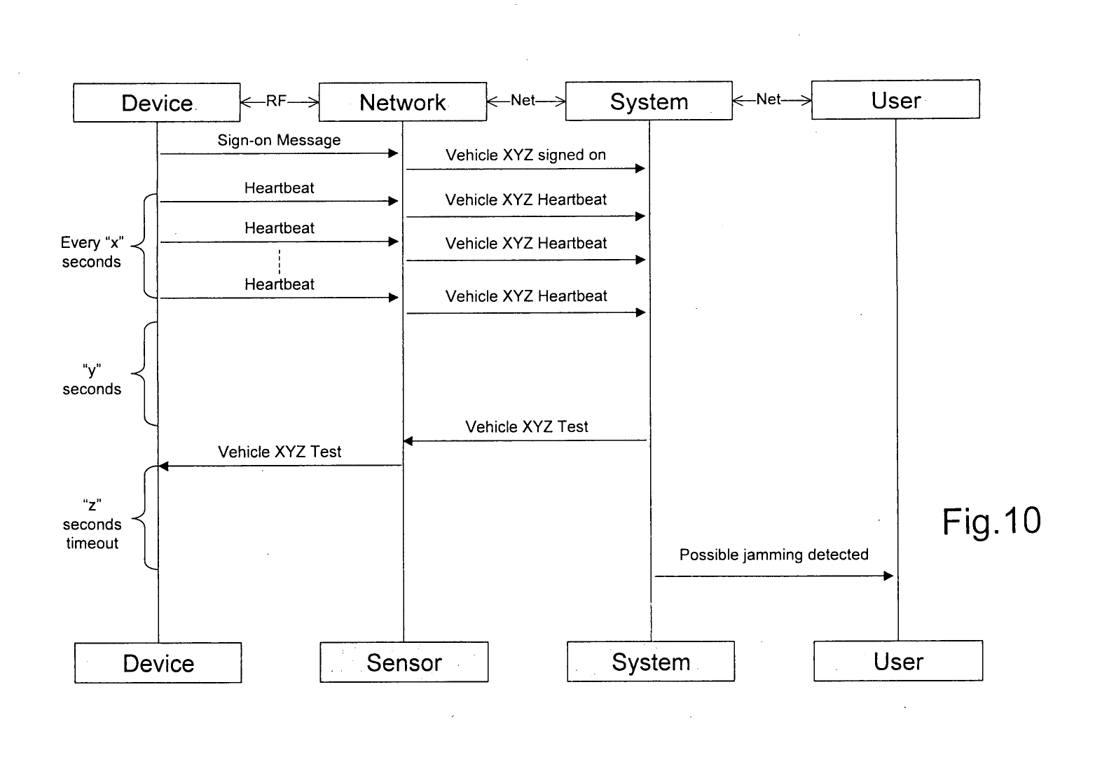

FIGS. 7, 9 and 10 illustrate a still further alternative passive jamming detection system. This system is similar to that of FIG. 6 except that instead of messages being initiated by the network, the system is vehicle device-initiated. Thus, the in-vehicle transceiver 12 periodically transmits a “sign on” message every x seconds, as a “heartbeat”. The nearest sensor, sensor A in FIG. 7, responds with a “signed on” reply. This may be initiated internally within the sensor, or remotely through the network. As with the FIG. 6 embodiment, removal of the vehicle must be detected to ensure removed vehicles do not participate in the jamming detection system. As before, a “leaving network” or sign-off message from the vehicle transceiver 22 renders that vehicle ignored for the purposes of jamming detection. If a sensor which has previously received “sign on” messages fails to receive the same messages from a vehicle which is indicated as still within the network (as not having sent a “leaving network” message) then this is indicative of a jamming event. Preferably, the system uses a plurality of vehicles distributed over the securable area 6. As shown in FIG. 10, failure to receive a sign on message for a predetermined period of y seconds prompts a “vehicle test” message from the control system via the network and sensor 9 to the vehicle, requiring an internal test of certain vehicle and/or vehicle transceiver 22 functionalities terminating in a “vehicle OK” message assuming vehicle functionality is normal, but the absence of which is indicative of a jamming event, and triggering a jamming alarm for a period of “z” seconds.

1. A vehicle security system for use in a predefined area comprising:
radio frequency receiving means for receiving a vehicle alarm signal from a subscribing vehicle in the event of attempted vehicle tampering or removal;
control means for receiving said signal and communicating to a user as an alarm message; and
means for detection of radio frequency signal jamming or attempted jamming, and for providing a jamming alarm signal for communication to a user.

2. A vehicle security system according to claim 1 wherein said means for detection of radio frequency signal jamming comprises one or more noise detectors adapted to detect radio frequency noise at a specified frequency or frequency range and to output a jamming alarm if said detected noise exceeds a predetermined threshold.

3. A vehicle security system according to claim 2 wherein said radio frequency receiving means comprise an array of sensors each comprising transceivers, the sensor array being distributed over the predefined area.

4. A vehicle security system according to claim 3 wherein said noise detectors are incorporated into said sensors.

5. A vehicle security system according to claim 3 wherein said noise detectors are incorporated into subscribing vehicles.

6. A vehicle security system according to claim 5 wherein said noise detectors are incorporated into vehicle transceiver units within subscribing vehicles.

7. A vehicle security system according to claim 3 wherein said sensors are connected to a control centre which receives said vehicle alarm signals and jamming alarm indications.

8. A vehicle security system according to claim 3 wherein said noise detectors are dedicated noise detector units separate from said sensors, in radio frequency communication with said sensors.

9. A vehicle security system according to claim 5 wherein said noise detectors are adapted to detect an increasing noise signal, and to output a jamming indicating as a radio frequency signal at a higher amplitude than said detected noise.

10. A vehicle security system according to claim 2 wherein said noise detectors are adapted to output a jamming alarm signal on detection of an excessive noise condition only after a predetermined time.

11. A vehicle security system according to claim 1 wherein said means for detecting of radio frequency jamming comprise at least one radio frequency transmitter adapted to send test messages to a radio frequency receiver, a jamming indication signal being generated in the absence of receipt of said test message.

12. A vehicle security system according to claim 11 wherein an array of sensors is provided distributed over said predefined area, said sensors comprising transceivers which constitute each of said vehicle alarm receiving means and said radio frequency receivers of said jamming detection means, and said radio frequency transmitters, said sensors being adapted to periodically send test messages to other sensors, the system generating a jamming indication in the event of the absence of receipt of said test messages.

13. A vehicle security system according to claim 11 comprising an array of sensors distributed over said predefined area, said sensors comprising transceivers which constitute said vehicle alarm receiving means and said radio frequency transmitters, and further comprising an array of monitoring devices including further transceivers, wherein the sensors are adapted to send test signals to said monitoring devices which on receipt in turn send acknowledge signals back to the transceivers of said sensors, the system generating a jamming indication in the event of the absence of an acknowledge signal.

14. A vehicle security system according to claim 11 comprising an array of sensors distributed over said predefined area, said sensors comprising transceivers which constitute said vehicle alarm receiving means and said radio frequency transmitters, wherein the sensors are adapted to send test messages to in-vehicle transceivers which in response to such test messages return acknowledge signals to the sensors, the system generating a jamming indication in the event of the absence of an acknowledge signal.

15. A vehicle security system according to claim 14 wherein the sensors are further adapted to receive signals from vehicles which are leaving the predefined area, the system preventing the absence of acknowledge signals from such vehicles from triggering jamming indications.

16. A vehicle system according to claim 11 comprising an array of sensors distributed over said predefined area, said sensors comprising transceivers which constitute said vehicle alarm receiving means and said radio frequency transmitters, wherein the sensors are further adapted to receive test signals sent from in-vehicle transceivers, and in response to generate and transmit acknowledge signals to in-vehicle transceivers, the absence of an acknowledge signal to said in-vehicle transceiver generating a jamming indication signal.

17. A vehicle security system according to claim 16 wherein the sensors are further adapted to receive signals from vehicles which are leaving the predefined area, the system preventing the absence of acknowledge signals from such vehicles from triggering jamming indications.

18. A vehicle security system according to claim 3 wherein the sensors are connected to a control centre which includes a database of data relating to subscribing vehicles and their owners.

19. A vehicle security system according to claim 1 for use in a predefined area which has one or more defined exit points, the system further comprising exit restraint means for securing on request said area exit points against vehicle exit, and processing means for processing vehicle alarm signals from a subscribing vehicle within said area and outputting command signals to said exit restraints.

20. A vehicle security system according to claim 19 wherein said exit restraint means comprise one or more of movable barriers, grilles or wheel traps.

21. A vehicle security system according to claim 1 further in combination with an in-vehicle security device, said device comprising in-vehicle sensing means which sense tampering with the vehicle or unauthorized operation, and outputting said alarm signal, and signal transmission means which transmit said alarm signal to said signal receiving means.

22. A vehicle security system according to claim 21 wherein the in-vehicle sensing means comprise one or more of a door sensor, hood sensor, ignition sensor, and vehicle interior movement sensor.

23. A vehicle security system according to claim 21 further comprising vehicle immobilising means.

24. A vehicle security system according to claim 23 wherein the vehicle immobilising means comprise one or more of a starter motor cut-out, fuel pump cut-out, fuel line cut-out and electrical fuse burn.

25. A vehicle security system for use in a predefined area comprising:
an array of sensors including radio frequency transceivers distributed over the predefined area for receipt of a radio frequency vehicle alarm signal from a subscribing vehicle in the event of vehicle tampering or removal;
control means connected to the sensor array for receipt of an alarm signal and for communication to a user;
a plurality of radio frequency noise detectors incorporated into said sensor array configured to detect radio frequency noise at a specific frequency or frequency range and to output an alarm signal if the detected noise exceeds a predetermined threshold.

26. A vehicle security system for use in a predefined area comprising:
an array of sensors each including radio frequency transceivers distributed over the predefined area for receipt of a radio frequency alarm signal from a subscribing vehicle in the event of vehicle tampering or removal;
control means connected to the sensor array for receipt of an alarm signal and communication to a user;
wherein the sensors are configured to send radio frequency system test signals to other sensors, the absence of receipt by said other sensors triggering a jamming alarm condition communicated to a user by said control means.
